(19) United States
(12) Patent Application Publication
(10) Pub. No.: US 2021/0121762 A1
(43) Pub. Date: Apr. 29, 2021

(54) SYSTEM FOR SCHEDULING A SPORTING EVENT

(71) Applicant: Shaji Ul Mulk Nawab Shahtaj, Dubai (AE)

(72) Inventor: Shaji Ul Mulk Nawab Shahtaj, Dubai (AE)

(21) Appl. No.: 16/980,829

(22) PCT Filed: Mar. 14, 2019
(86) PCT No.: PCT/IB2019/052062

§ 371 Date: Sep. 14, 2020

(30) Foreign Application Priority Data
Mar. 14, 2018 (IN) 201811009407

(51) Int. Cl. A63B 71/06; G06Q 10/10

(52) U.S. Cl. CPC A63B 71/0616; A63B 2102/20; G06Q 10/1093

(57) ABSTRACT

A system for scheduling a sporting event is disclosed. The system receives information regarding a set of six teams, each team comprising twelve players; divides the set of six team into a first group and a second group, each of the two groups comprising three teams; and generates, for each of the two groups, as part of first round, a match schedule, the schedule indicative of which teams play against the other in their respective group along with time of the play, each play/match being of a defined time period and each team getting a maximum of 10 overs for batting. Next, the system generates another schedule wherein as part of second round, top team of the first group plays with the bottom team of the second group, bottom team of the first group plays with the top team of the second group, and the two middle teams play against each other. Finally the system generates schedules for semi finals and finals Each play/match lasts for 90 minutes.

### FIELD OF DISCLOSURE

The present disclosure relates to playing competitive sports. In particular it pertains to playing a sporting event such as Cricket.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Cricket has a history starting from about late 16^{th} century in England, and has been played globally since 19^{th} century. International matches (or plays, the two terms being used interchangeably herein) have been played since 1844 and Test cricket began, retrospectively recognized, in 1877. Cricket is the world's second most popular spectator sport after association football. Governance is by the International Cricket Council (ICC) which has over one hundred countries and territories in membership although only twelve play Test cricket. The inaugural test matches were played in 1877, when an England touring team in Australia played two matches against full Australian XIs.Test matches are played between national representative teams with “Test status”, as determined and conferred by the International Cricket Council (ICC). The two teams of 11 players play a four-innings match, which may last up to five days (or longer in some historical cases).

The first limited-over international match took place at Melbourne Cricket Ground in 1971 as a time-filler after a Test match had been abandoned because of heavy rain on the opening days. It was tried simply as an experiment and to give the players some exercise, but turned out to be immensely popular. Limited-over internationals (LOIs or ODIs—one-day internationals) have since grown to become a massively popular form of the game, especially for busy people who want to be able to see a whole match. The International Cricket Council reacted to this development by organizing the first Cricket World Cup in England in 1975, with all the Test-playing nations taking part. Limited-over cricket has the advantage of delivering a result to spectators within a single day, thereby increasing its appeal to people increasingly short of time in present fast-paced times, and hence have proven to be immensely successful commercially.

A One-Day International (ODI) is a form of limited-overs cricket, played between two teams with international status, in which each team faces a fixed number of overs, usually 50. The Cricket World Cup is played in this format. One-Day International matches are also called Limited Overs Internationals (LOI), although this generic term may also refer to Twenty20 International matches. They are major matches and considered the highest standard of List A, limited overs competition.

Most ODI cricket takes place in a stand-alone series between two nations, often immediately before or after a Test series. Triangular or quadrangular series are also common. There are two major ODI tournaments which feature most or all permanent ODI teams, and often also associate members: Cricket World Cup, played every four years since 1975, and ICC Champions Trophy, played every two years or four years since 1998.The other major multi-country ODI tournament is the Asia Cup, organized by the Asian Cricket Council since 1983. It has mainly featured Pakistan, Sri Lanka, Bangladesh and India. However, it has also featured Hong Kong (2004 Asia Cup, 2008 Asia Cup), UAE (2004 Asia Cup, 2008 Asia Cup) and Afghanistan (Asia Cup 2014).

However, format as above leads to a lot of dissatisfaction amongst audience as well as the players. The audience is unhappy since only one play happens in a day while cricket playing teams and players are many. Hence the audience loses out opportunities to see better players/teams play and finally an overall victor to emerge, unless they are prepared to come for several days. In present times of fast paced action and quick gratification the audience expects much more fun and excitement then that possible through present format and scheduling of cricket matches.

Hence there is a need in the art for a system of scheduling cricket plays that obviates handicaps such as above. The system should be able to deliver conclusive results at the earliest, with continuous fast paced fun and action to keep the audience engrossed and entertained.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

Some of the objects of the present disclosure, which at least one embodiment herein satisfies are as listed herein below.

It is an object of the present disclosure to provide for a system that enables multiple matches of cricket to be scheduled as per requirements of a tournament organizer.

It is an object of the present disclosure to provide for a system that enables cricket matches to be played in a fast paced novel format.

It is an object of the present disclosure to provide for a system that enables cricket matches to be played in a format that keeps the audience totally involved and delivers maximum excitement to the audience.

### SUMMARY

The present disclosure mainly relates to playing cricket matches. More particularly, it relates to a system to schedule cricket plays/matches in a manner so as to make them more fast paced and interesting.

In an aspect, a system for scheduling cricket plays is disclosed, the system including: a non-transitory storage device having embodied therein one or more routines operable to facilitate procurement of the product; and one or more processors coupled to the non-transitory storage device and operable to execute the one or more routines, wherein the one or more routines can include: a team information receive module, which when executed by the one or more processors, can receive a set of six teams, each team comprising 12 players; a grouping module, which when executed by the one or more processors, can divide said set of six teams into a first group and a second group, each of the two groups comprising three teams, and a scheduling module, which when executed by the one or more processors, can generate, for each of the two groups, as part of first round, a match schedule, said schedule indicative of which teams play against the other in their respective group along with time of said play, each play being of a defined time period and each team getting a maximum of 10 overs for batting.

In another aspect, as part of the second round of the proposed sporting event, top team of the first group can play with the bottom team of the second group, bottom team of the first group can play with the top team of the second group, and the two middle teams can play against each other.

In yet another aspect, top four teams from the second round can qualify for the semi-finals, based on winning of which the finals can be played between the top two teams.

In an aspect, the defined time period can be 90 minutes.

In an aspect, a method for scheduling cricket matches is disclosed, the method including: receiving, at a computing device, a set of six teams, each team comprising 12 players; dividing, at the computing device, said set of six team into a first group and a second group, each of the two groups comprising three teams; and generating, at the computing device, for each of the two groups, as part of first round, a match schedule, said schedule indicative of which teams play against the other in their respective group along with time of said play, each play being of a defined time period and each team getting a maximum of 10 overs for batting.

In another aspect of the method, as part of second round, top team of the first group can play with the bottom team of the second group, bottom team of the first group can play with the top team of the second group, and the two middle teams can play against each other.

In yet another aspect of the method, top four teams from the second round can qualify for the semi-finals, based on winning of which the finals can be played between the top two teams.

In an aspect of the method, the defined time period can be 90 minutes.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates architecture of system proposed to illustrate its overall working in accordance with an exemplary embodiment of the present disclosure.

FIG. 2 illustrates functional modules of system proposed in accordance with an exemplary embodiment of the present disclosure.

FIG. 3 illustrates a method of working of system proposed in accordance with an exemplary embodiment of the present disclosure.

FIG. 4A, 4B and 4C illustrate examples of schedules that can be generated using the present disclosure in accordance with an exemplary embodiment of the present disclosure.

FIG. 5 illustrates an exemplary computer system 500 in which or with which embodiments of the present invention may be utilized.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) toperform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

In an implementation, a computing device used herein may be any of a variety of types of computing device, including without limitation, a desktop computer system, a data entry terminal, a laptop computer, a notebook computer, a tablet computer, a handheld personal data assistant, a smartphone, a body-worn computing device incorporated into clothing, a computing device integrated into a vehicle (e.g., a car, a bicycle, etc.), a server, a cluster of servers, a server farm, etc.

In another aspect, relevant modules of the proposed system can be configured to be operatively connected to a website, or be part of a mobile application that can be downloaded on a mobile device that can connect to Internet. In such fashion the proposed system can be available 24*7 to its users. Any other manner of implementation of the proposed system or a part thereof is well within the scope of the present disclosure/invention.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

In an aspect, a system for scheduling cricket plays is disclosed, the system including: a non-transitory storage device having embodied therein one or more routines operable to facilitate procurement of the product; and one or more processors coupled to the non-transitory storage device and operable to execute the one or more routines, wherein the one or more routines can include: a team information receive module, which when executed by the one or more processors, can receive a set of six teams, each team comprising 12 players; a grouping module, which when executed by the one or more processors, can divide said set of six team into a first group and a second group, each of the two groups comprising three teams, and a scheduling module, which when executed by the one or more processors, can generate, for each of the two groups, as part of first round, a match schedule, said schedule indicative of which teams play against the other in their respective group along with time of said play, each play being of a defined time period and each team getting a maximum of 10 overs for batting.

In another aspect, as part of second round, top team of the first group can play with the bottom team of the second group, bottom team of the first group can play with the top team of the second group, and the two middle teams can play against each other.

In yet another aspect, top four teams from the second round can qualify for the semi-finals, based on winning of which the finals can be played between the top two teams.

In an aspect, the defined time period can be 90 minutes.

In an aspect, a method for scheduling cricket matches is disclosed, the method including: receiving, at a computing device, a set of six teams, each team comprising 12 players; dividing, at the computing device, said set of six team into a first group and a second group, each of the two groups comprising three teams; and generating, at the computing device, for each of the two groups, as part of first round, a match schedule, said schedule indicative of which teams play against the other in their respective group along with time of said play, each play being of a defined time period and each team getting a maximum of 10 overs for batting.

In another aspect of the method, as part of second round, top team of the first group can play with the bottom team of the second group, bottom team of the first group can play with the top team of the second group, and the two middle teams can play against each other.

In yet another aspect of the method, top four teams from the second round can qualify for the semi-finals, based on winning of which the finals can be played between the top two teams.

In an aspect of the method, the defined time period can be 90 minutes.

It would be appreciated that although the present system has been described with respect to a cricket based sporting event, any other sport based event is well within the scope of the present invention.

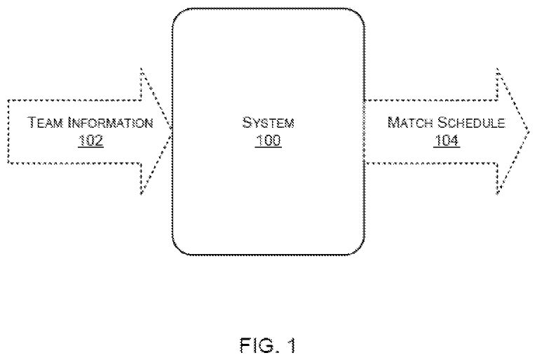

FIG. 1 illustrates architecture of system proposed to illustrate its overall working in accordance with an exemplary embodiment of the present disclosure.

In an aspect, proposed system enables information regarding various teams to be provided to it, as illustrated at 102 based upon which proposed system 100 can output a match schedule 104, match schedule 104 illustrating which teams are going to play against which teams and at what time and day. The match schedule pertains to a tournament with several participating teams, at end of which tournament winners, runners up and other teams can be declared based upon their performance in the tournament matches (interchangeably termed as plays herein).

In an aspect, the match schedule 104 may include dividing various playing teams into groups, determining an initial schedule wherein teams of one group play against each other and determining subsequent schedules wherein teams of one group play against teams of other groups in an iterative manner whereby the teams can finally be ranked to determine top team, first runner up, second runner up etc.

Various means can be employed to determine ranking of teams. For instance, in a group various teams can be ranked according to total number of matches won by them. Other variables of cricket such as total runs, run rate, wide balls, boundary hits (such as sixer and fourer, for instance), fouls and penalties awarded, wickets lost, overs bowled, no balls, leg byes, and the like can all be factored in. Different weights can be given to different such parameters so as to arrive at a final score for each time, on basis of which various teams can be ranked

Ranking can also include specific player parameters that can be factored in so as to make as level a playing field as possible and match teams as close as possible to each other in terms of skill levels etc. so as to have well-fought plays. For example, a cricket icon may start with a negative score, or his score may be multiplied by a “leveling factor” to arrive at score to be considered. All these permutations and combinations to enable ranking of a team are fully a part of the present disclosure.

Team information 102 may include specific team factors that may help determine a schedule. For instance, if a team is arriving from a remote location to host country's location, the team maybe scheduled for its first match after a pre-determined ‘jet lag’ period is over.

Team information 102 can include player specific parameters as well on basis of which proposed system can determine groupings and/or schedules. For instance, a team may have the world's best batsmen lineup while another may have the best bowler's lineup. Proposed system may be enabled to match the teams again in the finals, irrespective of their performance in earlier rounds. Or the system may schedule a match between these teams only on a holiday, to enable maximum audience participation/ticket sales. All such combinations are fully a part of the present disclosure.

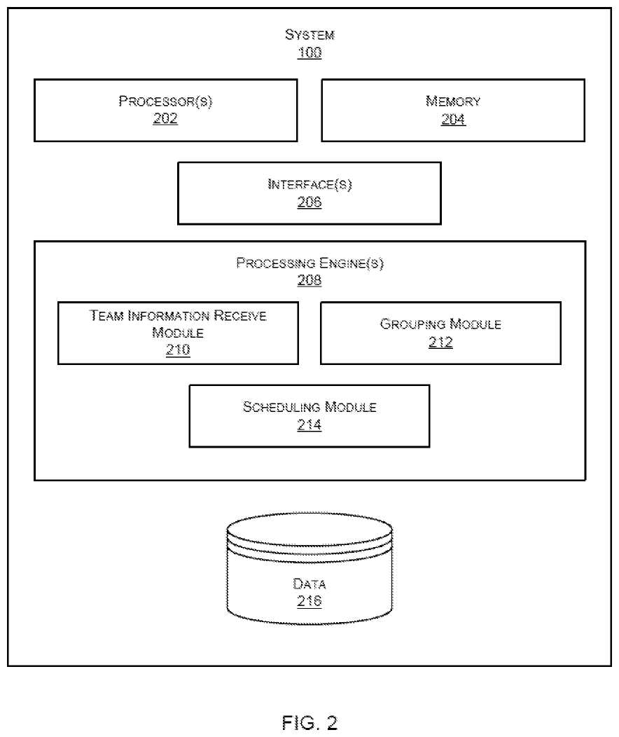

FIG. 2 illustrates functional modules of system proposed in accordance with an exemplary embodiment of the present disclosure.

In an aspect, system 100 proposed may include one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the system 100. The memory 204 may store one or more computer-readable instructions or routines, which may be fetched and executed to create or share the data units over a network service. The memory 204 may include any non-transitory storage device including, for example, volatile memory such as RAM, or non-volatile memory such as EPROM, flash memory, and the like.

In another aspect, system 100 may also include an interface(s) 206. The interface(s) 206 may include a variety of interfaces, for example, interfaces for data input and output devices, referred to as I/O devices, storage devices, and the like. The interface(s) 206 may facilitate communication of the system 100 with various devices coupled to the system 100. The interface(s) 206 may also provide a communication pathway for one or more components of the system 100. Examples of such components include, but are not limited to, processing engine(s) 208 and data 216.

The processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may include a processing resource (for example, one or more processors), to execute such instructions. In the present examples, the machine-readable storage medium may store instructions that, when executed by the processing resource, implement the processing engine(s) 208. In such examples, the system 100 may include the machine-readable storage medium storing the instructions and the processing resource to execute the instructions, or the machine-readable storage medium may be separate but accessible to system 100 and the processing resource. In other examples, the processing engine(s) 208 may be implemented by electronic circuitry.

The data 216 may include data that is either stored or generated as a result of functionalities implemented by any of the components of the processing engine(s) 208. For instance team 102 data (as elaborated in FIG. 1) as well as results data of various plays may be stored in data 216 and retrieved as required for proper grouping of teams and scheduling of their matches.

In an aspect, the engine(s) 208 may include a team information receive module 210, a grouping module 212 and a scheduling module 216. Besides, there could be other engines(not shown) that may implement functionalities that supplement applications or functions performed by the system 100 or the processing engine(s) 208. It would be appreciated that these are only exemplary modules and any other module or sub-module can be included as part of the proposed system. These modules too can be merged or divided into super-modules or sub-modules as may be configured and can be spread across one or more computing devices operatively connected to each other using appropriate communication technologies

In an aspect, team information receive module 210 can receive a set of six teams, each team comprising 12 players and can pass all relevant information concerning these teams to the grouping module 212. The grouping module 212 can divide the set of six teams into a first group and a second group, each of the two groups comprising three teams and pass all relevant information concerning the groups so formed to the scheduling module 214. Based upon this information received, the scheduling module 214 can generate, for each of the two groups, as part of first round, a match schedule, said schedule indicative of which teams play against the which others other in their respective group along with time of said play, each play being of a defined time period and each team getting a maximum of 10 overs for batting.

As elaborated above, team information module 210 can receive team information 106. Further, team information 106 can include team specific or player specific factors, as well as other factors such as circumstantial factors so as to ensure maximum audience participation.

In another aspect, scheduling module 214 can generate another schedule after the first round is over. The second schedule can enable, as a part of second round, top team of the first group to play with the bottom team of the second group, bottom team of the first group to play with the top team of the second group, and the two middle teams to play against each other. For the purpose team information module 210 can be provided information regarding top teams, middle teams and bottom teams of each group consequent to the completion of the first round of play as elaborated above.

In yet another aspect, the top four teams from the second round can qualify for the semi-finals, based on winning of which the finals can be played between the top two teams. Scheduling module 214 can generate schedules for the finals as well as the semi-finals, based upon relevant team information that it can receive via team information module 210 upon completion of the second round and, thereafter, the semi-finals round.

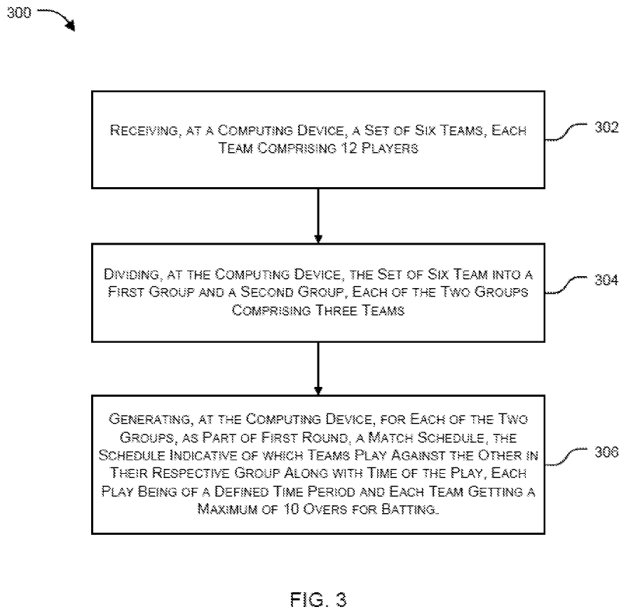

FIG. 3 illustrates a method of working of system proposed in accordance with an exemplary embodiment of the present disclosure.

In an aspect, the proposed method can be described in general context of computer executable instructions. Generally, computer executable instructions can include routines, programs, objects, components, data structures, procedures, modules, functions, etc., that perform particular functions or implement particular abstract data types. The method can also be practiced in a distributed computing environment where functions are performed by remote processing devices that are linked through a communications network. In a distributed computing environment, computer executable instructions may be located in both local and remote computer storage media, including memory storage devices.

The order in which the method as described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system.

In an aspect, the method may include a step 302 of receiving, at a computing device, a set of six teams, each team comprising 12 players.

Further, the method may include a step 304 of dividing, at the computing device, the set of six team into a first group and a second group, each of the two groups comprising three teams, and a step 306 of generating, at the computing device, for each of the two groups, as part of first round, a match schedule, the schedule indicative of which teams play against the other in their respective group along with time of the play, each play being of a defined time period and each team getting a maximum of 10 overs for batting.

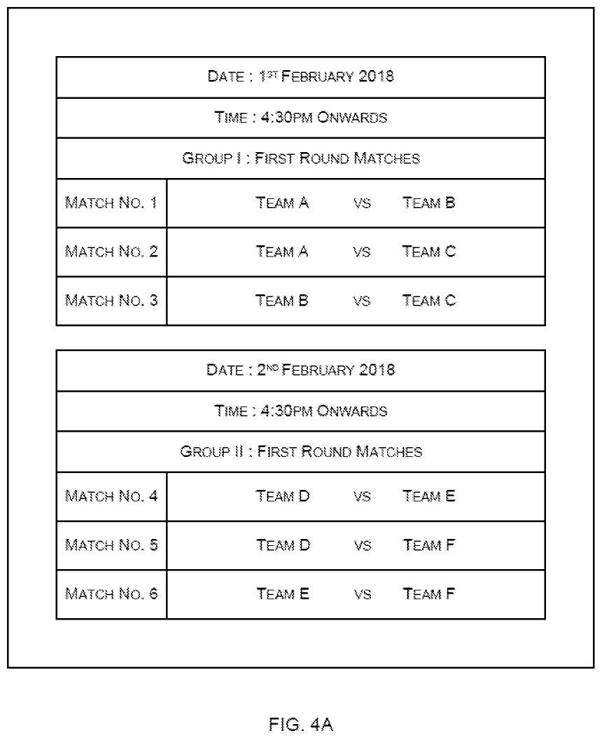

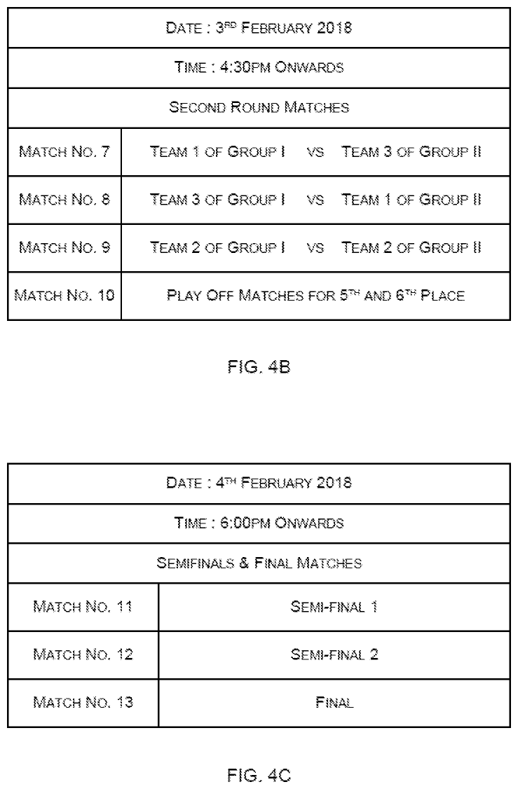

FIG. 4A, 4B and 4C illustrate examples of schedules that can be generated using the present disclosure in accordance with an exemplary embodiment of the present disclosure.

As illustrated in FIG. 4A, proposed system can divide teams playing in the tournament into different groups. In an exemplary embodiment, with six teams playing, proposed system can divide the teams into Group I comprising Team A, Team B and Team C; and Group II comprising Team D, Team E and Team F.

It can be readily appreciated that there can be different numbers of teams and different grouping arrangements. The example of six teams divided into two groups is only for the purpose of explanation and not to be construed as a limitation. Proposed system can handle any number of teams and groups.

Further, proposed system can determine a first round match schedule for each group, as illustrated at FIG. 4A. The schedule can include date, time and match to be played and their sequence. For instance, first match to be played on 1 Feb. 2018 at 4:30 can be between team A and Team B. Likewise, matches between different teams may be scheduled.

In an aspect, proposed system can handle multiple matches being played simultaneously at different venues. The venues may be close to each other or may be in different parts of the city/country/world. Team information 102 (as elaborated in FIG. 1) can include location information of each team as well to facilitate setting up of the groups and further schedules thereafter.

In another aspect, after completion of firstround of play, proposed system can determine schedule for the second round, as illustrated in FIG. 4B. Team rankings as determined from the first round of play in Group I teams and Group II teams can be provided to proposed system (as team information 102) and proposed system can generate/determine schedule for the second round based upon parameters provided to it by, for instance, system administrators.

In an exemplary embodiment, proposed system can generate a schedule for match no. 7 as shown that can be for team 1 of group I with team 3 of group II (wherein 1 and 3 denote rankings of the team in respective groups. For instance, first team in Group I against third team in Group III and likewise for other teams/rankings)

In an exemplary embodiment, proposed system can automatically determine team rankings for various rounds based upon performance of various teams and players in previous round. Such performance details can be provided to proposed system as part of team information 102, and pre-determined evaluation parameters provided to the proposed system. Such parameters can be, for instance, total number of matches won by a team so far, total runs scored by a team in previous round/all rounds till then, run rate, wide balls, sixers, fouls and penalties awarded and the like. Different weights can be given to different such parameters so as to arrive at a final score for each team, on basis of which various teams can be ranked In an exemplary embodiment, proposed system can take appropriate inputs as elaborated automatically from a scoring system to automatically determine the rankings

In yet another aspect, as illustrated in FIG. 4C, proposed system can determine a semi final and final schedule based upon the second round performance/ranking of various teams. As illustrated in FIG. 4C, match 11 can be a first semifinal, match 12 a second semifinal and match 13 the final.

As already elaborated, various factors can be provided to proposed system that can determine the schedules. For instance, proposed system can be enabled to schedule a final match only on a Sunday, or only between specified teams irrespective of their performance (that can be termed, for instance, ‘match of the Giants’), or only at specified time etc. and proposed system can generate the schedules accordingly. All such variations, permutations and combinations are fully a part of the present disclosure.

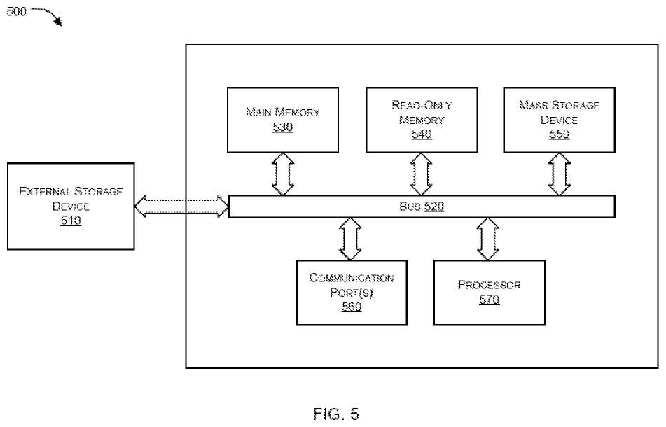

FIG. 5 illustrates an exemplary computer system 500 in which or with which embodiments of the present invention may be utilized.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown in the figure, computer system 500 includes an external storage device 510, a bus 520, a main memory 530, a read only memory 540, a mass storage device 550, communication port 560, and a processor 570. A person skilled in the art will appreciate that computer system 500 may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 570 may include various modules associated with embodiments of the present invention.

Communication port 560 can be any of an RS-232 port for use with a modem based dialup connection, a 10/100 Ethernet port, a Gigabit or 10 Gigabit port using copper or fiber, a serial port, a parallel port, or other existing or future ports. Communication port 560 may be chosen depending on a network, such a Local Area Network (LAN), Wide Area Network (WAN), or any network to which computer system 500 connects. Memory 530 can be Random Access Memory (RAM), or any other dynamic storage device commonly known in the art. Read only memory 540 can be any static storage device(s) e.g., but not limited to, a Programmable Read Only Memory (PROM) chips for storing static information e.g., start-up or BIOS instructions for processor 570. SANs and VSANs may also be deployed. Mass storage 550 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 520 communicatively couples processor(s) 570 with the other memory, storage and communication blocks. Bus 520 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system. Optionally, operator and administrative interfaces, e.g. a display, keyboard, and a cursor control device, may also be coupled to bus 520 to support direct operator interaction with computer system 500. Other operator and administrative interfaces can be provided through network connections connected through communication port 560.

External storage device 510 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM). Components described above are meant only to exemplify various possibilities. In no way should the aforementioned exemplary computer system limit the scope of the present disclosure.

As already elaborated, while the proposed system has been elaborated as above to include all the main modules, it is completely possible that actual implementations may include only a part of the proposed modules or a combination of those or a division of those into sub-modules in various combinations across multiple devices that can be operatively coupled with each other, including in the cloud. Further the modules can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. Therefore, all possible modifications, implementations and embodiments of where and how the proposed system is configured are well within the scope of the present invention.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### ADVANTAGES OF THE INVENTION

The present disclosure provides fora system that enables multiple matches of cricket to be scheduled as per requirements of a tournament organizer.

The present disclosure provides for a system that enables cricket matches to be played in a fast paced novel format.

The present disclosure provides for a system that enables cricket matches to be played in a format that keeps the audience totally involved and delivers maximum excitement to the audience.

I claim:

1. A system for scheduling a sporting event, said system comprising:
a non-transitory storage device having embodied therein one or more routines operable to facilitate scheduling of the event; and
one or more processors coupled to the non-transitory storage device and operable to execute the one or more routines, wherein the one or more routines include:
a team information receive module, which when executed by the one or more processors, receives a set of six teams, each team comprising 12 players;
a grouping module, which when executed by the one or more processors, divides said set of six team into a first group and a second group, each of the two groups comprising three teams; and
a scheduling module, which when executed by the one or more processors, generates, for each of the two groups, as part of first round, a match schedule, said schedule indicative of which teams play against the other in their respective group along with time of said play, each play being of a defined time period and each team getting a maximum of 10 overs for batting.

2. The system as claimed in claim 1, wherein, as part of second round, top team of the first group plays with the bottom team of the second group, bottom team of the first group plays with the top team of the second group, and the two middle teams play against each other.

3. The system as claimed in claim 1, wherein top four teams from the second round qualify for the semi-finals, based on winning of which the finals are played between the top two teams.

4. The system as claimed in claim 1, wherein the defined time period is 90 minutes.

5. A method comprising
receiving, at a computing device, a set of six teams, each team comprising 12 players;
dividing, at the computing device, said set of six team into a first group and a second group, each of the two groups comprising three teams; and
generating, at the computing device, for each of the two groups, as part of first round, a match schedule, said schedule indicative of which teams play against the other in their respective group along with time of said play, each play being of a defined time period and each team getting a maximum of 10 overs for batting.

6. The method as claimed in claim 5, wherein, as part of second round, top team of the first group plays with the bottom team of the second group, bottom team of the first group plays with the top team of the second group, and the two middle teams play against each other.

7. The method as claimed in claim 5, wherein top four teams from the second round qualify for the semi-finals, based on winning of which the finals are played between the top two teams.

8. The method as claimed in claim 5, wherein the defined time period is 90 minutes.
